(19) United States
(12) Patent Application Publication
(10) Pub. No.: US 2003/0033173 A1
(43) Pub. Date: Feb. 13, 2003

(54) Insurance contract management system, method for controlling insurance contract and portable terminal device for the system and method

(76) Inventors: Koji Suzuki, Yokohama (JP); Shirou Horii, Hitachinaka (JP); Kenichi Hamazaki, Yokohama (JP); Naoki Mori, Yokohama (JP)

Correspondence Address: MCDERMOTT WILL & EMERY, 600 13TH STREET, N.W., WASHINGTON, DC, 20005-3096, US

(21) Appl. No.: 10/109,039

(22) Filed: Mar. 29, 2002

(30) Foreign Application Priority Data
Aug. 8, 2001 (JP) 2001-240579

(51) Int. Cl. G06F 17/60; H04Q 7/20

(52) U.S. Cl. 705/4; 455/422

(57) ABSTRACT

When an application for start of an insurance contract having the contents agreed in advance between a user and an insurance company is made from a portable telephone of the user to an insurance contract computer, the insurance contract computer starts an insurance period and when an application for stop is sent, the insurance period is stopped. An insurance premium is figured out in accordance with a time count of the insurance period. Various kinds of input-troublesome information to be presented to the insurance company at the time of insurance contract are registered in advance in a memory device connected in advance to the insurance contract computer. The portable telephone has the position measuring function and can periodically notify the insurance contract computer of the present position of the portable telephone. The insurance contract computer calculates a moving distance of the user from that position and adjusts the insurance premium.

### BACKGROUND OF THE INVENTION

The present invention relates to an insurance contract system for enabling a user to control an insurance contract (for example, effectuation or end of an insurance contract or adjustment of insurance conditions such as insurance period, insurance premium or insured amount) by utilizing a portable mobile communication terminal such as portable telephone.

Conventionally, various kinds of insurance such as traffic accident insurance targeted to an individual to guarantee a traffic accident, automobile insurance targeted to a car owner to guarantee costs incurred in a car accident and overseas travel insurance targeted to an oversea traveler to guarantee costs of injuries and sickness caused during travel have been contrived. As for each insurance, an insurance premium (insured amount) is set in accordance with such a condition as insurance period and the contents of compensation.

By subdividing the contract condition at the time of entry into insurance, insurance goods of a condition optimized to individual subscribers can be presented. On the other hand, the more the contract condition is subdivided, the more ramified the classification of insurance premium or insured amount becomes, which force the subscribers to have difficulties in understanding the contents of insurance goods, because of their widespread diversity of classification.

Especially, even when the insurance affiliation period is selectable at the time of entry, the user sometimes tends to make a contract of an unnecessarily long period owing to troublesome contract procedures. Taking overseas travel insurance, for instance, even for travels of even departure date, the departure time differs depending on flights used and in spite of the fact that time consumed for travel differs by half a day or more between an early morning flight and a late night flight, travels are sometimes handled in the same way when the contract period sorting is defined in a unit of day, for example, how many overnight and how many days. As a result, in the case of midnight departure and early morning homecoming, the insurance premium becomes comparatively expensive.

Further, in a case, because of complexity of the procedures for insurance contract, the user cannot make an entry into insurance as soon as he or she thinks of it and meets with an accident without insurance contract, failing to receive any compensation. This leads to a problem that from a standpoint of insurance company, the company misses a business chance of acquiring an insurance contract.

Furthermore, in spite of the fact that risk of causing injuries or accidents differs with a going-out time, utilizable traffic means and an average moving distance per day of a contractor from the viewpoint of accident insurance or with a boarding time and a running distance from the viewpoint of automobile insurance, there is a case that the differences in risk are not dealt with discriminatively by the insurance premium.

In addition, it matters that an insurance entry contract can be made at only a place where an insurance company or its agency is mainly located or a contract machine of an insurance company is installed. In recent years, an insurance contract can be made by utilizing Internet but the procedure for making an entry of an insurance certificate forwarded after a contract application and returning it is often required to make it necessary to use a terminal connectable to the Internet, thus leaving behind the complexity.

As a literature disclosing a method of claiming and processing a car insurance premium, JP-A-2001-76035 is available, according to which a car navigation device is used to pay an insurance premium in accordance with a use frequency and use conditions of a car.

The known method is targeted to accident insurance for cars and is not targeted to accident insurance for users. The car navigation device used in the method merely transmits data and is not based on such a technical idea that the host is controlled from the terminal side.

### SUMMARY OF THE INVENTION

Accordingly, an object of the invention is to make a predetermined insurance condition adjustable in accordance with user's circumferences through a simplified procedure.

Another object of the invention is to make a periodicity insurance condition such as insurance period adjustable in compliance with user's desire through a simplified procedure.

Still another object of the invention is to make a moneyed insurance condition such as insurance premium or insured amount in compliance with user's conditions through a simplified procedure.

According to one aspect of the invention, an insurance contract management system using a computer comprises a signal receiving unit for receiving an insurance control signal concerning a given insurance contract from a portable mobile communication terminal carried by a user, and a insurance control unit, responsive to the received insurance control signal, to control a contract condition (for example, periodicity condition) of the insurance contract.

In a preferred embodiment, a portable telephone having the voice communication function is used as the portable mobile communication terminal but the portable telephone is not limitative. For example, other kinds of apparatus such as PDA or portable personal computer having the data communication function may be used. In a preferred embodiment, as an example of control of the periodicity condition, start date and hour and stop date and hour of the insurance period may be adjusted but the start and stop of the insurance period is not limitative.

In one mode of a preferred embodiment, a control operation for operating the insurance period on real time base in response to the control signal from the portable telephone is carried out in such a manner that as soon as a start request signal from the portable telephone is received, the insurance period is started and as soon as a stop request signal is received, the insurance period is stopped. In another mode, a control operation is also carried out in such a manner that designation of start date and hour and stop date and hour is received from the portable telephone and the insurance period is started when the start date and hour comes and the insurance period is stopped when the stop date and hour comes.

In a preferred embodiment, the insurance control unit also controls effectuation of an insurance contract (entry into insurance) or end of the insurance contract (cancellation of insurance) in response to the received insurance control signal.

In a preferred embodiment, memory unit for storing in advance identity information such as name and address of the user is further provided and the insurance control unit makes reference to the identity information of the user stored in the memory unit as necessary when performing control concerning the insurance contract. Through this, when transmitting the insurance control signal from the portable mobile communication terminal, the user need not input his or her identity information to the portable mobile communication terminal, thus simplifying user's operation.

In a preferred embodiment, the insurance control unit can also control a moneyed condition (for example, insurance premium or insured amount) concerning the insurance contract in accordance with the controlled periodicity condition.

In a preferred embodiment, the signal receiving unit further receives an information signal concerning a position or moving distance of the portable mobile communication terminal and the insurance control unit can control the moneyed condition concerning the insurance contract in response to the received information signal concerning a position or moving distance.

In a preferred embodiment, the signal receiving unit further receives an information signal concerning distance relation between the portable mobile communication terminal and a predetermined specified apparatus (for example, somewhat closely distant or more distant) and the insurance control unit can control the periodicity condition or moneyed condition concerning the insurance contract in response to the received information signal concerning the distance relation.

In a preferred embodiment, the signal receiving unit further receives an information signal concerning a state of use of a specified traffic unit (means of transportation) by the user (for example, an automobile being in use or in non-use) and the insurance control unit can control the periodicity condition or moneyed condition in response to the received information signal concerning the use state of the traffic unit.

In a preferred embodiment, the signal receiving unit further receives a change request signal for the once controlled periodicity condition (for example, a request signal for extension of the once set insurance period) from the portable mobile communication terminal and the insurance control unit can change the periodicity condition in response to the received change request signal.

In a preferred embodiment, there is provided insurance contents notifying unit that automatically notifies predetermined information concerning an insurance contract to a specified contact place desired by the user.

In a preferred embodiment, there are further provided accident supposing unit for monitoring communication conditions of the portable mobile communication terminal to suppose occurrence of an accident of the user and accident reporting unit for reporting the supposed occurrence of an accident to a predetermined contact place.

According to a second aspect of the invention, a method for controlling an insurance contract by using a computer comprises a step of receiving an insurance control signal concerning the insurance contract from a portable mobile communication terminal possessed by the user, and a step of controlling a contract condition concerning the insurance contract (for example, periodicity condition) in response to the received insurance control signal.

According to third aspect of the invention, the portable mobile communication terminal is a communication terminal usable by the user for controlling an insurance contract and comprises a radio communication unit for connecting the insurance contract to an insurance contract computer adapted to manage the insurance contract, and an insurance control signal transmitting unit for transmitting an insurance control signal for control of an insurance condition (for example, periodicity condition) of the insurance contract.

In a preferred embodiment, the communication terminal further comprises memory unit for storing user identification information for causing the insurance contract computer to identify the user, and the insurance control signal transmitting unit transmits the user identification information stored in the memory unit, together with the insurance control signal, to the insurance contract computer. Through this, the user need not input his or her identity information to the communication terminal and operation of insurance control can be simplified.

In another preferred embodiment, the communication terminal further comprises a unit for generating an information signal concerning a position or moving distance of the communication terminal, and the insurance control signal transmitting unit transmits the information signal to the insurance contract computer.

In another preferred embodiment, the communication terminal further comprises a unit for generating an information signal concerning distance relation between the communication terminal and a predetermined specified apparatus, and the insurance control signal transmitting unit transmits the information signal to the insurance contract computer.

In another preferred embodiment, the communication terminal further comprises a unit for generating an information signal concerning a state of use of specified traffic unit by the user, and the insurance control signal transmitting unit transmits the information signal to the insurance contract computer.

In still another preferred embodiment, the communication terminal further comprises a unit for informing the user of the present state of a periodicity condition of the insurance contract. Specifically, the unit for informing the user can be constructed of a display or lamp for performing notification visually and a loudspeaker, buzzer or bell for performing notification audibly.

In another preferred embodiment, the communication terminal further comprises an insurance control key operable to control a contract condition of the insurance contract, and the insurance control signal can be transmitted by operating the key only.

According to the invention, the predetermined insurance condition can be adjusted in accordance with user's circumstances through the simplified procedure using the portable terminal device.

Other objects, features and advantages of the invention will become apparent from a description of the embodiments of the invention taken in conjunction with the accompanying drawings.

### BRIEF DESCRIPTION OF THE DRAWINGS

FIG. 1 is a block diagram showing the overall construction of an insurance contract system according to a first embodiment of the invention.

FIG. 2 is a block diagram showing the construction of a portable telephone used in the first embodiment.

FIG. 3 is a block diagram showing the construction of an insurance contract computer used in the first embodiment.

FIG. 4 is a sequence diagram showing the flow of a process between start and stop of an insurance contract in the first embodiment.

FIGS. 5A to 5D are diagrams showing examples of graphical user interface pictures displayed on portable telephone 100 in the process of starting the insurance contract.

FIGS. 6A to 6D are diagrams showing examples of graphical user interface pictures displayed on the portable telephone 100 in the process of ending the insurance contract.

FIG. 7 is a block diagram showing the overall construction of an insurance contract system according to a second embodiment of the invention.

FIG. 8 is a sequence diagram showing the flow of a process between start and stop of an insurance contract in the second embodiment.

FIG. 9 is a block diagram showing different specified apparatus for position measurement.

FIG. 10 is a diagram showing an example of a specified apparatus for performing by itself position measurement and distance calculation and transmitting the results to the portable telephone 100.

FIG. 11 is a diagram showing an example of construction of a user interface in the portable telephone 100.

FIG. 12 is a flowchart showing the general flow of an insurance contract controlling process in the portable telephone of FIG. 11.

FIG. 13 is a sequence diagram showing the flow of a modified example of the process between start and stop of an insurance contract.

FIG. 14 is a flowchart of an additional processing function capable of being incorporated in insurance contract computer 300.

FIG. 15 is a flowchart showing the flow of a process concerning measures when the position and moving distance of the user (portable telephone) is detected by utilizing, for example, GPS and measures against the event that power supply of the portable telephone is switched off, the portable telephone is lost or battery-up (death of battery) occurs during travel.

### DESCRIPTION OF THE EMBODIMENTS

The invention will now be described by way of example with reference to the accompanying drawings.

Terms used in the following embodiments will herein be described briefly. It is to be noted that the definition of the following terms is a mere example for convenience of description of the embodiments. Accordingly, the scope of the present invention is in no way limited by only the domain according to the following definition.

Referred to by “insurance subscriber” is a person who contracted with an insurance company for an insurance contract.

Referred to by “insurance period” is a period over which duty of payment of insurance money takes place concomitantly with occurrence of insurable contingency risk on the basis of an insurance contract.

Referred to by “control of insurance contract” is effecting (concluding) or ending an insurance contract or adjusting a given insurance condition (for example, insurance period, insurance premium or insured amount) in the effected insurance contract.

Referred to by “start of insurance contract” is starting an insurance period.

Referred to by “stop of insurance contract” is ending an insurance period. But, if possible on a contract, temporarily interrupting the insurance period (the insurance period can resume later) can also be categorized in the meaning of “stop of insurance contract”.

In embodiments to be described hereinafter, a user is an insurance subscriber who made an insurance contract with an insurance company for specified insurance goods and under this condition, the user controls a given insurance condition in the concluded insurance contract (for example, insurance period, insurance premium or insured amount) by using a portable telephone in accordance with the principle of the invention. However, the scope to which the present invention is applicable is not limited to this case. For example, not only adjustment of the insurance condition but also conclusion or end of an insurance contract can be controlled by using a mobile communication terminal carried with a user in accordance with the principle of the invention.

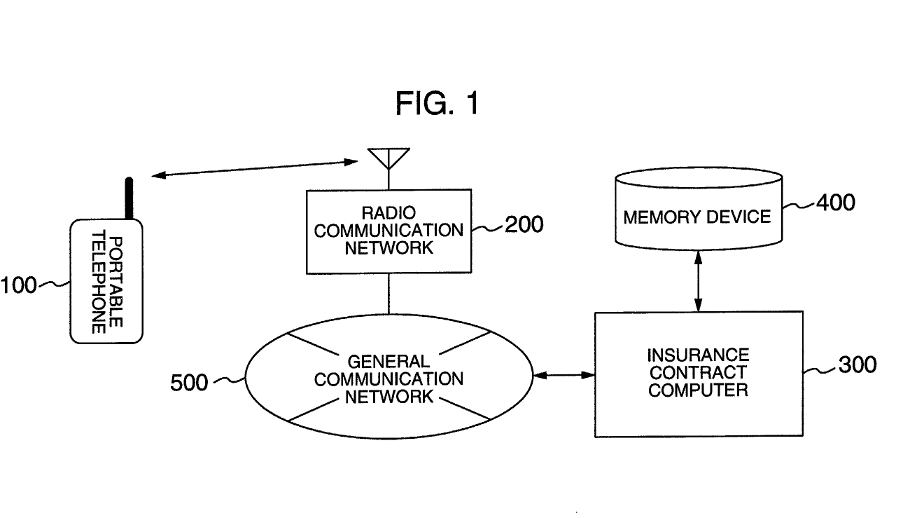

FIG. 1 is a block diagram showing the overall construction of an insurance contract system according to a first embodiment of the invention.

As shown in FIG. 1, a user has a portable telephone 100 with him or her. The portable telephone 100 is utilized as terminal for controlling an insurance contract in this insurance contract system. The portable telephone 100 can connect to an insurance contract computer 300 via a radio communication network 200 and a general communication network (for example, public telephone line, Internet or the like) 500 so as to make communication concerning an insurance contract. The insurance contract computer 300 works for an insurance company by processing such insurance business affairs as the procedure of subscriber registration (namely, insurance contract conclusion) of the user, start and end of an insurance period of the insurance contract and calculation and demand for an insurance premium. The insurance contract computer 300 has a memory device 400 on which insurance subscriber information such as identity particulars and portable telephone identification information of the insurance subscriber, insurance contract information such as contract number, insurance period and insurance premium of the insurance contract concluded by the insurance subscriber, and insurance premium information establishing a base of insurance premium calculation are stored. The insurance contract computer 300 may be constructed of a single computer machine or otherwise may be constructed of a plurality of computer machines; or may be installed at a single location or distributed to a plurality of locations.

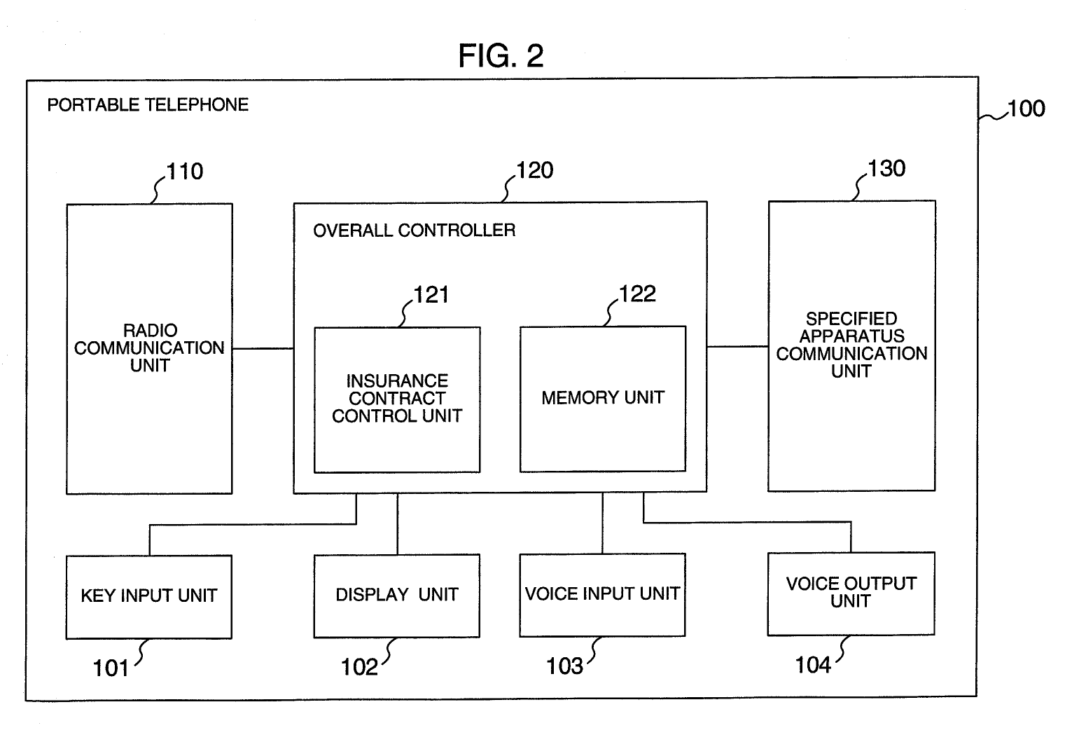

FIG. 2 shows the internal construction of the portable telephone 100 carried with the user.

In FIG. 2, a radio communication unit 110 has a circuit for transmitting/receiving a radio signal to/from the radio communication network 200 to connect to, for example, the insurance company contract computer 300 connected to the general communication network 500 or the Internet, thus permitting communication with a remote apparatus.

The radio communication unit 110 is connected with an overall controller 120. The overall controller 120 is adapted to control the whole of portable telephone 100, having an insurance contract control unit 121 and a memory unit 122. The overall controller 120 is connected with various kinds of user interface units, for example, a key input unit 101 for receiving a key input such as text from the user, a screen display unit 102 for displaying text and image, a voice input unit 103 for receiving a voice input from the user and a voice output unit 104 for delivering a voice message and various kinds of signal sounds.

The overall controller 120 controls the voice communication function and data communication function of the portable telephone 100. The portable telephone 100 according to the invention controls an insurance contract (for example, start and stop of the insurance contract) by utilizing the data communication function to communicate with the insurance contract host computer 300. To ensure the insurance contract to be controlled, the overall controller 120 has the insurance contract control unit 121 and memory unit 122.

Stored in the memory unit 122 are identification information of the portable telephone 100 (typically, a telephone number of the portable telephone 100), identity information such as name and address of the user (that is, a bearer of the portable telephone 100), an insurance subscriber ID of the user (that is, identification information for the insurance subscriber), a connection address of the insurance contract host computer 300 and an address note registered with names, telephone numbers and electric mail addresses of user's family, friends and work place. Also stored in the memory unit 122 is information about a history of an insurance contract the user controlled in the past by using the portable telephone 100 (for example, contract number of the insurance contract, insurance goods classification, start date and hour, stop date and hour and information received by a specified apparatus communication unit 130 to be described later).

The insurance contract control unit 121 connects to the insurance contract host computer 300 to fulfil the function of transmitting the portable telephone identification information (for example, telephone number of the portable telephone) to the insurance contract host computer 300, transmitting information for applying for start/stop of an insurance contract to the insurance contract host computer 300 and receiving history information of an insurance contract concluded by the user till then (for example, contract number, insurance goods classification, start/end date and hour of insurance period, indication as to whether the insurance period proceeds at present, and insurance premium) from the insurance contract host computer 300 and causing the user to confirm it.

Requests for various kinds of operations such as input of a dial number to the overall controller 120, input of a password number for user authentication, a request for connection to the insurance contract host computer 300 and a request for starting/stopping an insurance contact can be inputted by letting the user operate the key input unit 101. These input operations may be carried out through voice recognition by using the voice input unit 103. But, in the present embodiment, at least inputting the password number is carried out using only the key input unit 101 that permits steady input operation. The overall controller 120 displays progress conditions of a process for control of the insurance contract and other various processing conditions and status of the portable telephone on the screen display unit 102.

Also connected to the overall controller 120 is the specified apparatus communication unit 130. The specified apparatus communication unit 130 communicates with an external specified apparatus to function to acquire predetermined information utilized for control of the insurance contract and provide it to the overall controller 120.

As an example, GPS artificial satellites can be adopted as the external specified apparatus. In that case, the specified apparatus communication unit 130 incorporates a GPS module for the purpose of calculating the latitude and longitude at the present position on the basis of electric waves received from several GPS satellites and providing a calculation result to the overall controller 120. Information about the present position is used for figuring out a moving distance and whereabouts of the user, thereby ensuring that for example, start/stop of the insurance period of travel insurance or automobile insurance, the insurance premium or the insured amount can be adjusted in accordance with the figured-out values.

Alternatively, as the external specified apparatus, a portable telephone interface apparatus carried on an automobile, for instance, can be adopted which provides a specified signal from the automobile to the portable telephone 100. This on-board interface apparatus can be, for example, such a simplified radio signal generator that generates, inside the car, a weak radio signal receivable by the portable telephone 100 only when the portable telephone 100 is closely distant from the generator by a short distance suggesting that the portable telephone 100 exists inside the car (in other words, proving that the user is on the car). The generator may otherwise be wired to the portable telephone 100 inside the car. In this manner, it is possible to cause the portable telephone 100 to recognize whether the user is on the car. Alternatively, the interface apparatus carried on the car may be, for example, a more highly graded up communication apparatus that is connected to a control computer inside the car to read car status such as running distance and engine start conditions of the car and transmit the car status to the portable telephone 100 wirelessly or by wired line. Anyway, exemplarily adoptable as the communication system between the on-board interface apparatus and the portable telephone 100 is a short distance radio communication system using an electric wave at a frequency different from a frequency band utilized by the portable telephone 100 for communicating with the radio communication network 200, a communication system based on wired connection or a short distance radio communication system using infrared rays. The specified apparatus communication unit 130 of portable telephone 100 can send information obtained from the signal received from the on-board interface apparatus (information as to whether the user is on the car or information concerning a running distance and engine start conditions of the car) to the overall controller 120. On the basis of the information, start/stop of an insurance period, insurance, insurance premium or insured amount of automobile insurance, for instance, can be adjusted.

The aforementioned external specified apparatus and the specified apparatus communication unit 130 of portable telephone 100 are not particularly needed in the embodiment set forth so far but the most will be made of them in other embodiments to be described later.

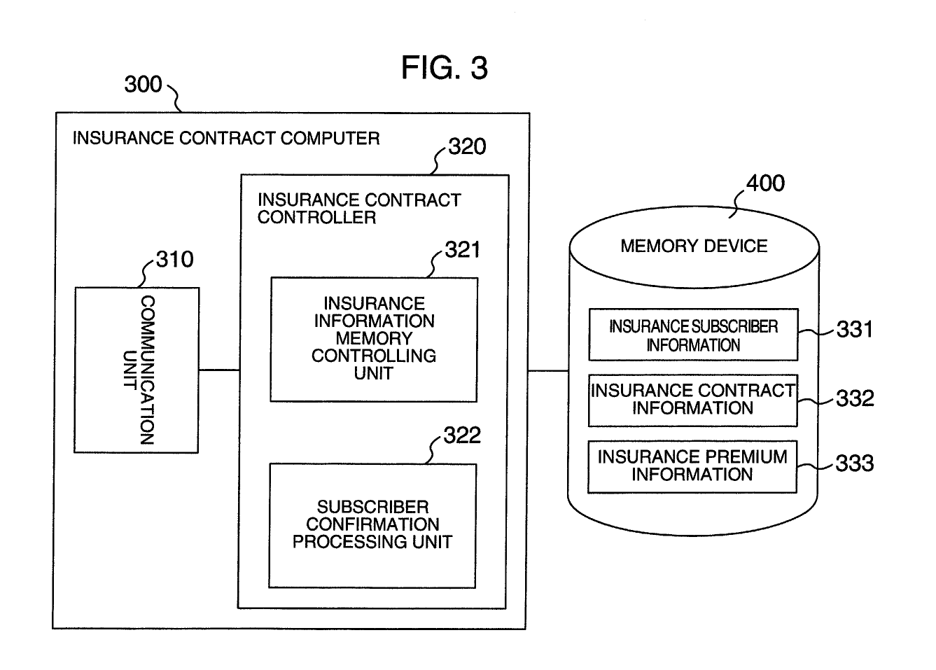

FIG. 3 is a block diagram showing the internal construction of the insurance contract computer 300.

In FIG. 3, a communication unit 310 communicates with the portable telephone 100 through the general communication network (such as public telephone line or Internet) 500.

An insurance contract controller 320 responds to insurance contract start application information or stop application information from the portable telephone 100 received by the communication unit 310 to perform a process for start/stop of an insurance contract by making reference to various kinds of information in the memory device 400. The insurance contract controller 320 includes an insurance information memory controlling unit 321 and a subscriber confirmation processing unit 322. The insurance information memory controlling unit 321 responds to the aforementioned insurance contract start/stop application information from the user to perform a process for read/write of various kinds of information in the memory device 400. On the other hand, the subscriber confirmation processing unit 322 carries out a user authentication process before acknowledging the receipt of the insurance contract start/stop application information coming from the portable telephone 100 of the user in order to decide whether the user is an insurance subscriber registered in advance.

Stored in the memory device 400 are data tables of insurance subscriber information 331, insurance contract information 332 and insurance premium information 333.

Registered in the table of subscriber information 331 in respect of all insurance subscribers registered at present are identity information such as names, addresses and birth dates of individuals, portable telephone identification information (for example, portable telephone numbers) of individuals, insurance subscriber ID's of individuals and authentication information such as password numbers or PIN (Personal Identification Number) of individuals. The information of individual insurance subscribers registered in the table of subscriber information 331 contains almost all particulars that must be presented to an insurance company or entered in a written contract when an insurance contract is made, for example, the aforementioned identity information such as names, addresses and birth dates. Accordingly, after having once entered insurance subscriber registration, the user can be freed, in principle, from a troublesome procedure of inputting the particulars. Thus, in making an application for insurance contract start or stop from the portable telephone 100 after the subscriber registration, an troublesome operation of inputting the particulars in the portable telephone 100 can be dispensed with and an operation to be carried out by the user is very simplified. The subscriber registration procedure (that is, insurance contract concluding procedure) can be carried out in on-line fashion in which the user connects to the insurance contract computer 300 by way of the portable telephone 100 or a personal computer or in off-line fashion in which the user entries a paper sheet of application for entry or affiliation and presents it to an insurance company.

Stored on the table of insurance contract information 332 in respect of the individual insurance subscribers is history information of insurance contracts including an insurance contract having its insurance period proceeding at present and insurance contracts concluded till now (for example, contract number, insurance goods classification, start date and hour and stop date and hour of insurance period, accumulated time of insurance period, indication as to whether the insurance period proceeds at present, insurance premium or insured amount).

Stored on the table of insurance premium information 333 is estimation base information needed when the insurance premium or insured amount is estimated in accordance with the accumulated time of insurance period and the behavior form of the user during the insurance period.

In accordance with a registered portable telephone identification number of a specified insurance subscriber, the insurance information memory controlling unit 321 can read insurance contract history information of the subscriber from the table of insurance contract information 332. Also, in accordance with a past insurance period of the specified insurance subscriber, the insurance information memory controlling unit 321 can read estimation base information applied to the insurance period from the table of insurance premium information 333, calculate an insurance premium by using the estimation base information and register the calculated insurance premium in the table of insurance contract information 332.

In the insurance contract system constructed as above, the user makes, in advance, an insurance contract with an insurance company for specified insurance goods (for example, specified travel insurance or specified automobile insurance) for which the insurance contract is controllable by the portable telephone and entries registration of the user as insurance subscriber in the insurance contract computer 300. Normally, particulars to be entered in a written contract for the purpose of making an insurance contract are registered in the insurance contract computer 300 in the phase of the insurance subscriber registration. Then, when the user transmits insurance contract start or stop application information from the portable telephone 100 at a desired time meeting an action schedule of his or her own, an insurance period of the insurance contract is started or stopped on real time base. Since the insurance subscriber information already registered can be used at the time of the insurance contract start/stop application, a troublesome operation of inputting the information by key can be unneeded. Then, on the basis of a time count (in a unit of hour or minute) between the start and stop of the insurance period operated from the portable telephone 100, an insurance premium is automatically calculated by the insurance contract computer 300 and the user is charged for it. In this manner, insurance applicable for only a necessary period in a unit of hour or minute can be realized by letting the user carry out a simplified application operation with the portable telephone 100.

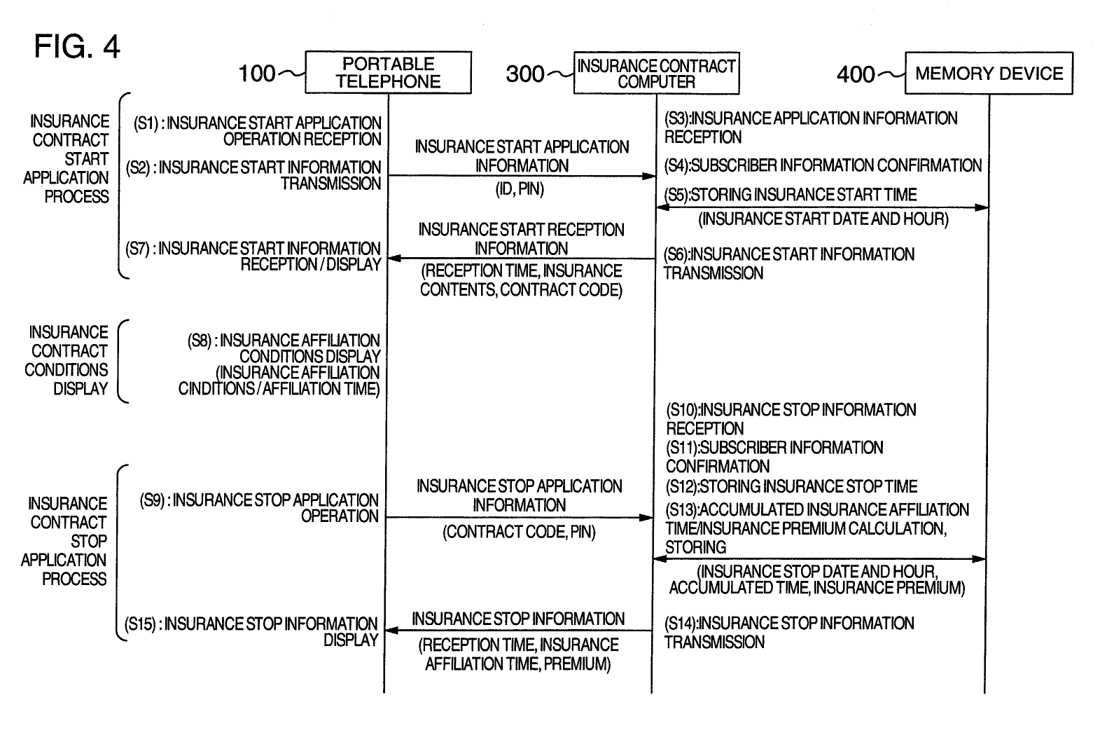

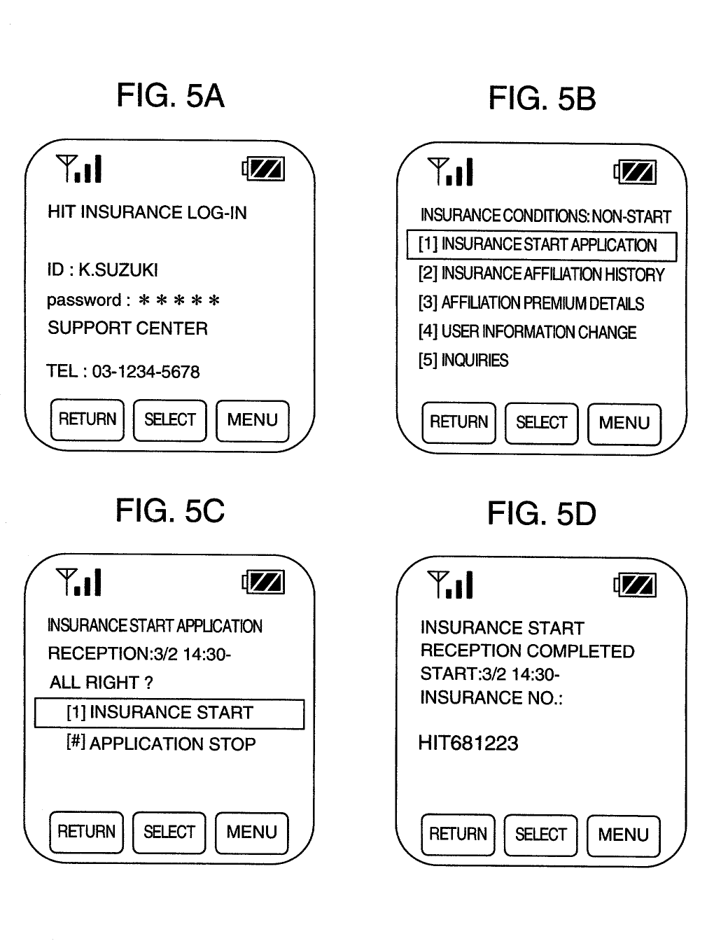

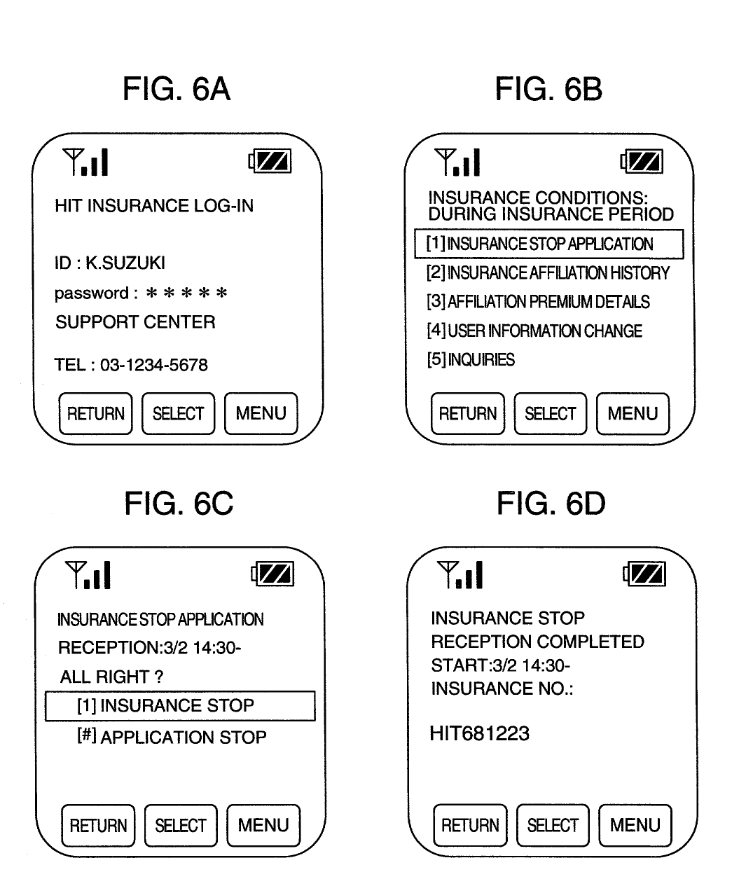

FIG. 4 is a sequence diagram showing the flow of a process between start and stop of an insurance contract in the present embodiment. FIGS. 5A to 5D show examples of a graphical user interface pictures displayed on the portable telephone 100 in the insurance contract start process. FIGS. 6A to 6D show examples of graphical user interface pictures displayed on the portable telephone 100 in the insurance contract end process.

Firstly, the flow of the insurance contract start process will be described.

In FIG. 4, when receiving a key operation for insurance contract start application by a user (S1), the portable telephone 100 transmits insurance start application information to the insurance contract computer 300 (S2). The insurance start application information contains, for example, an insurance subscriber ID of the user stored in advance in the portable telephone 100 and a password number inputted by the user by means of keys for confirmation of the user himself or herself.

Examples displayed on the screen of the portable telephone 100 when the insurance contract start application from the user is received are shown in FIGS. 5A to 5D. When the user selects “[1] insurance start application” on an insurance conditions picture of FIG. 5B, the screen switches to an insurance start picture of FIG. 5C. Then, when the user selects “[1] insurance start” on the screen of FIG. 5C, the insurance contract start application is acknowledged by the portable telephone 100 and sent to the insurance contract computer 300.

Receiving the contract start application information from the portable telephone 100 (S3), the insurance contract computer 300 first confirms subscriber information (S4) to decide whether the contract start application information comes from an authorized insurance subscriber. More particularly, the insurance information memory controlling unit 321 first retrieves an insurance subscriber ID and a personal password number corresponding to the portable telephone identification information from the insurance subscriber information 331 in the memory device 400 by using, as retrieval key, the portable telephone identification information (for example, telephone number) of the portable telephone 100 that has sent the contract start application information. Subsequently, the subscriber confirmation processing unit 322 collates the retrieved insurance subscriber ID and personal password number with insurance subscriber ID and password number contained in the received insurance start application information. If the two completely coincide with each other, it is determined that the insurance start application information comes from an authorized insurance subscriber.

With the insurance start application information determined as coming from the authorized insurance subscriber, the insurance contract computer 300 immediately causes the insurance information memory controlling unit 321 to assign a contract code specified to the insurance start application information, sets date and hour of reception of the insurance start application information as insurance start date and hour (namely, start date and hour of the insurance period) and stores the contract code and the insurance start date and time on the insurance contract information 332 in the memory device 400 (S5) and at the same time, it returns the insurance contract start information to the portable telephone 100 (S6). The insurance start information contains, for example, the aforementioned insurance start date and hour (the date and hour of reception of the insurance start application), contract code and contents of contract of the target insurance contract.

When the portable telephone 100 receives the insurance start information (S7), it displays a picture including messages for notifying completion of the insurance start application reception on the display unit 102. An example of the picture of the insurance start reception completion is shown in FIG. 5D.

Once the insurance period of the insurance contract has started, the user logs in the insurance contract computer 300 to open the insurance conditions screen (S8). Then, the insurance conditions as indicated by “during insurance period” are displayed on the insurance conditions screen as exemplified in FIG. 6B and besides, “[1] insurance stop application” menu is displayed in place of the “[1] insurance start application” menu on the picture during non-start shown in FIG. 5B. This display urges the user to notice that the user should prolong the insurance period unnecessarily by forgetting to make an application for insurance contract stop.

Next, the flow of the process for insurance contract stop will be described.

As shown in FIG. 4, when the portable telephone 100 receives a key operation of insurance contract stop application from the user (S9), it transmits insurance stop application information to the insurance contract computer 300. The insurance stop application information contains, for example, the insurance subscriber ID and contract code of the user stored in advance in the portable telephone 100 and the password number the user has inputted by keys to confirm the user himself or herself.

Examples of display on the screen of the portable telephone 100 when the aforementioned insurance contract stop application is received from the user are shown in FIGS. 6A to 6D. When the user selects “[1] insurance stop application” on the insurance conditions screen of FIG. 6B, the screen switches to the insurance stop picture of FIG. 6C and then, when the user selects “[1] insurance stop” on the picture of FIG. 6C, the insurance contract stop application is acknowledged by the portable telephone 100 and sent to the insurance contract computer 300.

Receiving the contract stop application information from the portable telephone 100 (S10), the insurance contract computer 300 first confirms the subscriber information (S11) to decide whether the contract stop application information comes from an authorized insurance subscriber. More particularly, the insurance information memory controlling unit 321 first retrieves the insurance subscriber ID and personal password number corresponding to the portable telephone identification information and contract code from the insurance subscriber information 331 by using, as retrieval key, the portable telephone identification information (for example, telephone number) of the portable telephone 100 that has sent the contract stop application information and the contract code contained in the contract stop application information. Subsequently, the subscriber confirmation processing unit 322 collates the retrieved insurance subscriber ID and personal password number with the insurance subscriber ID and password number contained in the received insurance stop application information and if the two completely coincide with each other, the unit 322 determines that the insurance stop application information comes from the authorized insurance subscriber.

When it is determined that the insurance stop application information comes from the authorized insurance subscriber, the insurance contract computer 300 immediately causes the insurance information memory controlling unit 321 to set date and hour of reception of the insurance stop application information as insurance stop date and hour (that is, insurance period stop date and hour) corresponding to the contract code contained in the insurance stop application information and stores the insurance stop date and hour on the insurance contract information 332 in the memory device 400 (S12). Concurrently therewith, the insurance information memory controlling unit 321 determines an accumulated time count of the insurance period from the insurance start date and hour and insurance stop date and hour of the contract code, calculates an insurance premium for the insurance period on the basis of the accumulated time count by using the estimation base information stored on the insurance premium information 333 in the memory device 400, and stores also the insurance premium on the insurance contract information 332 in the memory device 400 (S13). Subsequently, the insurance contract computer 300 immediately returns the insurance stop information to the portable telephone 100 (S14). The insurance stop information contains, for example, the aforementioned insurance stop date and hour (the reception date and hour of insurance stop application), contract code, accumulated time of insurance period and insurance premium.

Receiving the insurance stop information, the portable telephone 100 displays a picture for notifying insurance stop application reception completion on the display unit 102 (S15).

An example of the picture of insurance stop reception completion is shown in FIG. 6D.

According to the foregoing embodiment, when travel insurance, for instance, is to be controlled, the user makes an application for insurance start from the portable telephone 100 at the time when, for example, the user starts on travel, and makes an application for insurance stop at the time when the user returns from the travel, whereby the insurance period can be started and stopped on real time base in conformity with a practical travel schedule. In this manner, the user can make use of the insurance only during the period for the user to need the insurance and can be freed from paying an insurance premium for a superfluous period. Besides, the procedure for insurance start/stop application can be completed by merely inputting a password number to the portable telephone 100 and selecting several menus, demonstrating that the procedure can be simplified very much.

Even in case the travel is prolonged in excess of the initial schedule, the insurance period can be deferred without making an application for insurance stop until the travel ends. Accordingly, it is possible to avoid the conventionally raised problem that the insurance period terminates earlier than the end of travel and since then no compensation will be given for a possible accident.

In addition, there occurs a case that effective period of an insurance contract per se is long but a period for the insurance to be needed actually is part of the contract period. For example, in the case of long-term overseas travel insurance, it is sometimes desired that the insurance be applied during only an interval of time that the traveler is on a traffic unit (means of transportation) such as airplane or automobile. In such a case, an application for insurance start at a boarding time and an application for insurance stop at an alighting time may be made frequently each time when the traffic unit is used during the travel.

Next, an insurance contract system according to a second embodiment of the invention will be described.

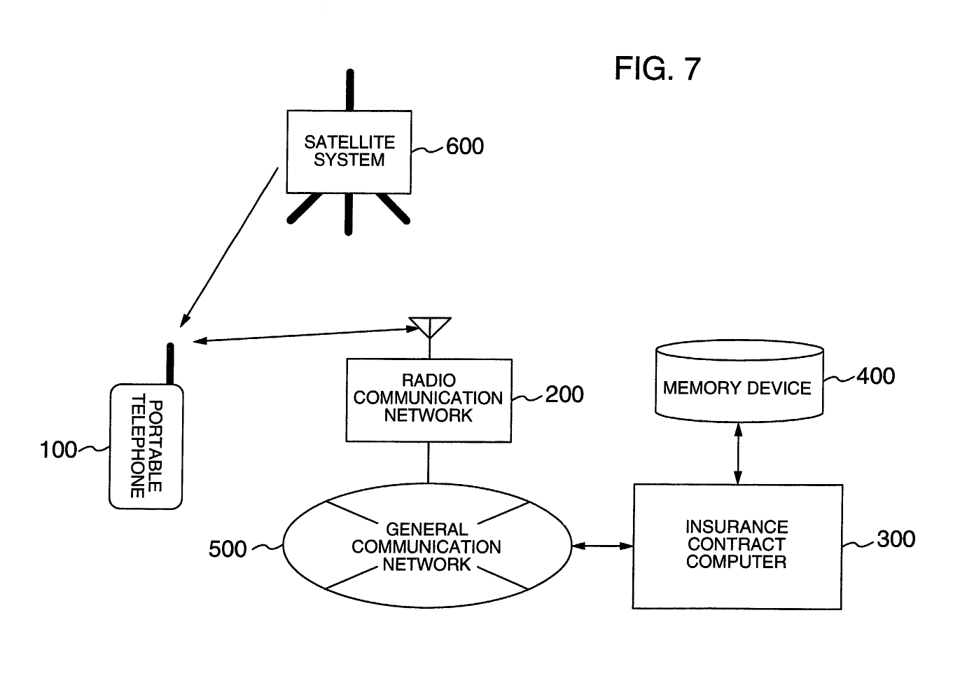

FIG. 7 shows the overall construction of the insurance contract system of this embodiment.

As shown in FIG. 7, the insurance contract system adds to the construction of the previously described FIG. 1 system a plurality of satellite systems for GPS 600 (only one is illustrated in the figure) used as the previously described external specified apparatus. A portable telephone 100 has, in the specified apparatus communication unit 130 as shown in FIG. 2, the position measuring function (GPS module) for figuring out the present position of the portable telephone 100 by receiving electric waves from the plurality of satellite systems 600.

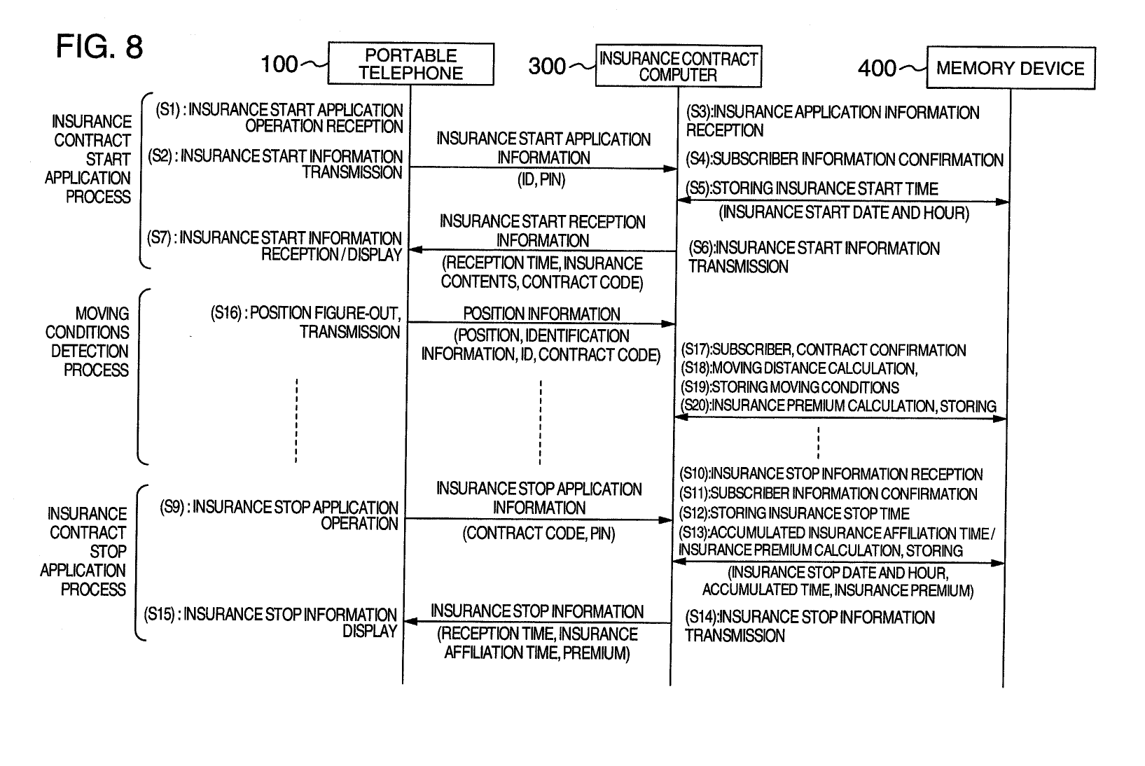

FIG. 8 shows the flow of a process between insurance contract start and stop in the present embodiment. In the flow shown in FIG. 8, the portable telephone 100 and insurance contract computer 300 basically operate in S1 to S15 as has been explained with reference to FIG. 4 (In FIG. 8, insurance contract condition display S8 shown in FIG. 4 is not depicted for simplicity of illustration). In addition, the portable telephone 100 periodically transmits figured out position information together with insurance subscriber ID and contract code to the insurance contract computer 300 during at least a period between insurance contract start and stop (that is, during an insurance period) (S16).

Each time that the position information from the portable telephone 100 is received, the insurance contract computer 300 examines which insurance subscriber and which contract code the receiving signal relates to (17) by using identification information (for example, telephone number) of the portable telephone 100, insurance subscriber ID and contract code that are contained in the receiving signal and consulting insurance subscriber information 331 and insurance contract information 332 shown in FIG. 3. When the result confirms that the receiving signal concerns a specified contract code of a subscriber of specified insurance whose insurance period proceeds at present, the insurance contract computer 300 calculates the latest moving distance on the basis of the received position information and the most recently past moving distance corresponding to the contract code already stored on the insurance contract information 332 (S18) and stores the calculated moving distance, the received position information and the date and hour of the position information on the insurance contract information 332 (S19). In this manner, moving conditions (date and hour, position and moving distance at individual time points) of the user during the insurance period are stored on the insurance contract information 332 (S19). On the basis of the stored moving conditions, the insurance contract computer 300 can calculate the insurance premium at intervals of constant period or at the time that the insurance period is stopped (S20, S13). In accordance with a method set up in advance pursuant to an agreement between the user and an insurance company, according to which method, for example, the longer the moving distance, the higher the insurance premium becomes or the longer the staying time in a region where the risk is high, the higher the insurance premium becomes, the insurance premium can be adjusted in conformity with the moving conditions.

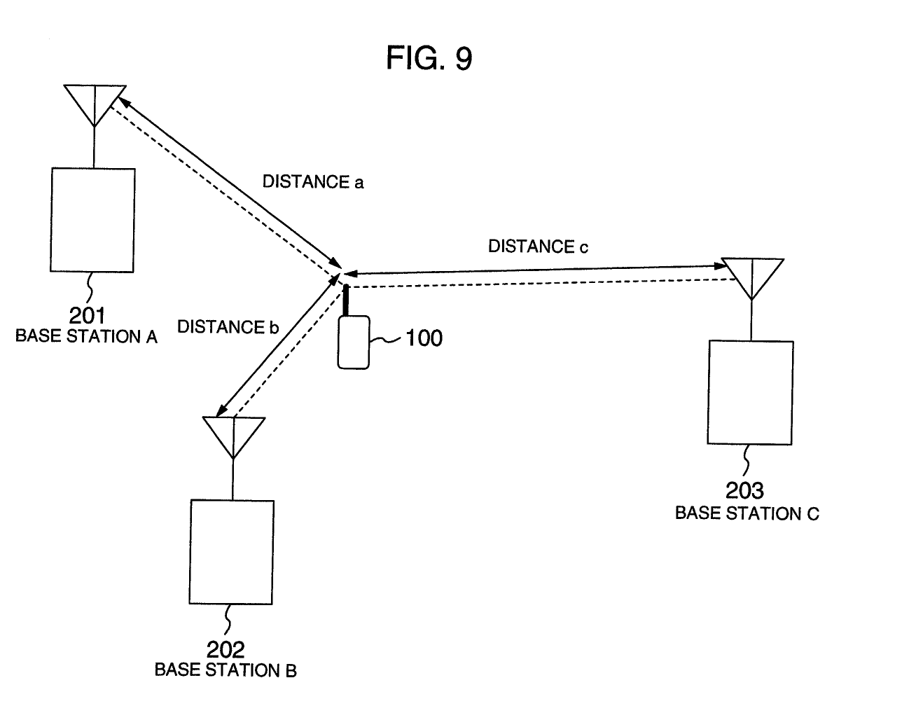

Incidentally, as the specified apparatus for position measurement, not only the aforementioned GPS satellite systems 600 but also other apparatus may be used. FIG. 9 shows an example of a different specified apparatus for position measurement.

As shown in FIG. 9, the portable telephone 100 uses, as the specified apparatus, a plurality of radio base stations 201 to 203 for portable telephone communication surrounding the portable telephone 100. By receiving position information of the base stations 201 to 203 transmitted from the surrounding base stations 201 to 203, the portable telephone 100 recognizes positions (for example, latitudes and longitudes) of the base stations 201 to 203. Further, by examining the reception intensity of reference signals transmitted from the base stations 201 to 203, the portable telephone 100 figures out a distance between each base station and portable telephone 100 and calculates the present position of the portable telephone 100 on the basis of the distances and the positions of base stations 201 to 203. In an alternative, on the basis of the ratio between reception intensity levels of the reference signals from the base stations 201 to 203 and the positions of base stations 201 to 203, the present position of the portable telephone 100 may be calculated. The thus calculated position is periodically notified from the portable telephone 100 to the insurance contract computer 300 as described previously.

For position measurement, other various methods may be employed. For example, on the basis of receiving electric field intensity levels of an electric wave received from the portable telephone 100 by the base stations 201 to 203 shown in FIG. 9, a position of the portable telephone 100 may be figured out on the side of the radio communication network 200 and the position information may be transmitted to the portable telephone 100. Alternatively, in case the position of the portable telephone 100 is figured out on the side of the radio communication network 200, the position information may not be routed to the portable telephone 100 but may be notified from the radio communication network 200 directly to the insurance contract computer 300 (for example, the insurance contract computer 300 may periodically inquire a center computer of radio communication network 200 about a position of the portable telephone 100).

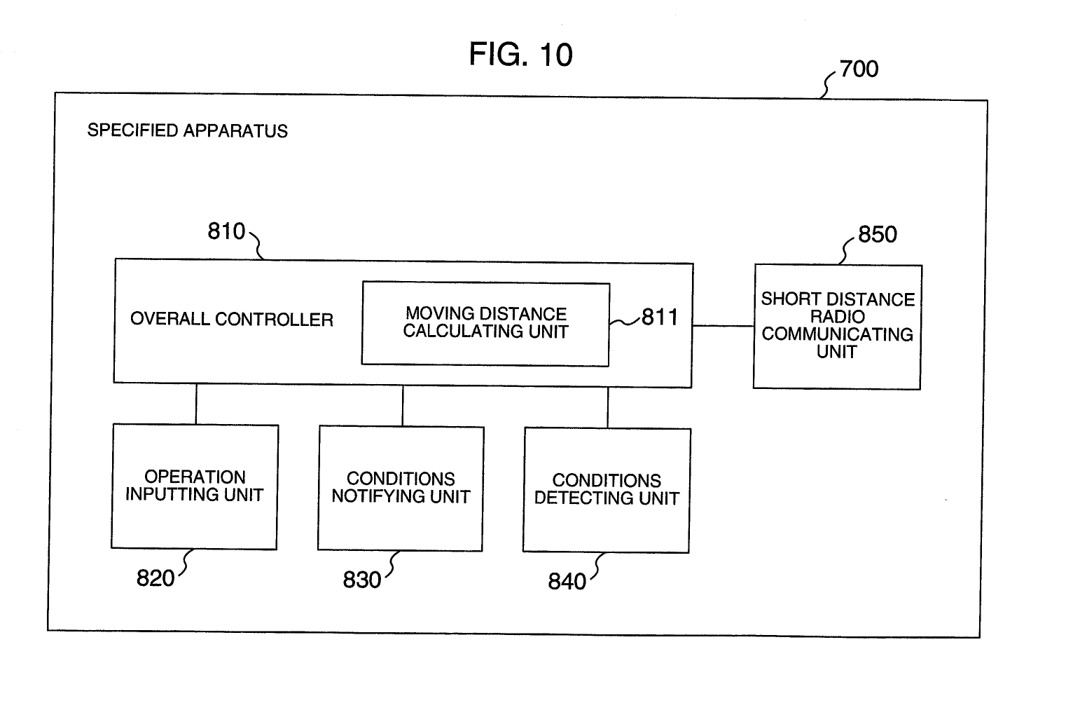

An apparatus for performing position measurement and distance calculation by itself and transmitting the results to the portable telephone 100 can also be used as the aforementioned specified apparatus. An example of such a specified apparatus is shown in FIG. 10.

A specified apparatus 700 shown in FIG. 10 is carried on, for example, an automobile and is so constructed as to detect or calculate the present position, moving distance and engine state of the automobile and notify the result to a portable telephone 100 present in the automobile.

More particularly, a condition detecting unit 840 of the specified apparatus 700 is connected with, for example, a control computer (not shown), a running device (not shown) or a car navigation device (not shown) in the automobile to detect the present position of the car and various car states such as engine state and fuel consumption amount and send them to an overall controller 810. The overall controller 810 is adapted to store the present position of the car and the various car states such as engine state and fuel consumption amount supplied from the condition detecting unit 840 and besides causes a moving distance calculating unit 811 to calculate a moving distance of the car on the basis of the present position and store the result.

An operation inputting unit 820 is operated by the user to initialize the specified apparatus 700 and input setting of the function of deciding what information is to be detected or calculated. A condition notifying unit 830 is adapted to indicate the present position and various car states such as engine state of the car grasped by the overall controller 810 and the calculated moving distance.

A short distance radio communicating unit 850 periodically modulates the information such as the present position and various car states such as engine state and fuel consumption amount of the car and the calculated moving distance that are grasped by the overall controller 810, together with identification information of the specified apparatus 700 (or identification information of the car), into a short distance radio signal and transmits it to the interior of the car.

The portable telephone 100 causes the specified apparatus communication unit 130 shown in FIG. 2 to receive the short distance radio signal transmitted from the specified apparatus 700. The intensity of the short distance radio signal is at such a level that only the portable telephone 100 being within a short distance from the specified apparatus can receive the signal, the short distance suggesting that the portable telephone 100 is inside the car or near the car (that is, the user is on the car or the user being outside the car substantially uses the car). Accordingly, when the user carries the portable telephone 100 and uses the car, the portable telephone 100 receives the short distance signal from the specified apparatus 700 but as the user leaves the car, it cannot receive the signal. The portable telephone 100 automatically recognizes that the user starts using the car at the time that the periodical reception of the short distance radio signal from the specified apparatus 700 is started (or at the time that information indicative of running start of the car such as engine start is received) and transmits a message to this effect, along with the insurance subscriber ID and contract code, to the insurance contract computer 300 (start of car use may be decided on the side of the insurance contract computer 300). Then, the portable telephone 100 receives the short distance radio signal from the specified apparatus 700 and periodically transmits the information indicative of various car states such as the present position, engine state, fuel consumption amount and moving distance and the car identification information that are contained in the received signal, together with the insurance subscriber ID and contract code, to the insurance contract computer 300. Also, at the time that the periodical reception of the short distance radio signal from the specified apparatus 700 disappears for a predetermined time (or at the time that information indicative of running stop of the car such as engine stop is received), the portable telephone 100 automatically recognizes that the user stops the use of the car and transmits a message to this effect, along with the insurance subscriber ID and contract code, to the insurance contract computer 300 (alternatively, the car use stop may be decided on the side of the insurance contact computer 300).

On the basis of the car state information received from the portable telephone 100, such as the car use start/stop received from the portable telephone 100, the present position periodically received between the use start and stop, the engine state, the fuel consumption amount and the moving distance, and the car identification information, the insurance contract computer 300 can calculate and adjust the insurance premium or insured amount of, for example, automobile insurance or travel insurance through a predetermined method.

An automatic control method may be adopted which automatically starts/stops an insurance contract in combination with the manual control method in which the user operates the portable telephone 100 to perform the start/stop of an insurance contract as has been described in the first embodiment or in place of the above method, on the basis of a signal from the specified apparatus 700 received by the portable telephone 100 (for example, in response to recognition of the use start/stop of the car based on the received signal). For example, in specified insurance concerning the use of an automobile, when any application for start of insurance contract dose not come from the user even at the expiration of a predetermined time (for example, 30 minutes) starting with recognition of start of the use of the car, there is a possibility that the user forgets to operate start and therefore, an insurance contract may be started automatically. Conversely, when, after the insurance contract has once been started, any application for insurance contract stop does not come from the user at the expiration of a predetermined time (for example, 24 hours) starting with recognition of stop of the use of the car, there is a possibility that the user forgets to operate stop and therefore the insurance contract may be stopped automatically. In case the automatic start or stop is carried out as above, such a handling sometimes opposes the intent of the user. Accordingly, a message to the effect that the automatic start or stop is carried out may immediately be notified to the user by electronic mail for portable telephone, for instance, and besides, the automatic start or stop may be so handled as to be cancelled later by a statement lodged by the user.

By using the plurality of specified apparatus exemplified in FIGS. 7 to 10 selectively or in combination, the insurance contract can be controlled by a method conforming to various kinds of behavior of the user. For example, when an automobile carrying the specified apparatus 700 as shown in FIG. 10 is used, the start/stop of insurance period and the insurance premium may be controlled on the basis of information received from the specified apparatus 700 by the portable telephone 100 or when an airplane is used, the insurance premium may be controlled on the basis of positions and date and hour measured by the portable telephone 100 at a departure airport and an arrival airport, respectively. Further, in case the specified apparatus 700 as exemplified in FIG. 10 is installed in user's own house, it can be determined by the portable telephone 100 in accordance with a receiving state of a short distance radio signal from the specified apparatus 700 that the user is “in” if the short distance radio signal is received for a constant time or more or the user is “out” if no reception occurs, thereby ensuring that an application start/stop process for accident insurance for instance can be controlled.

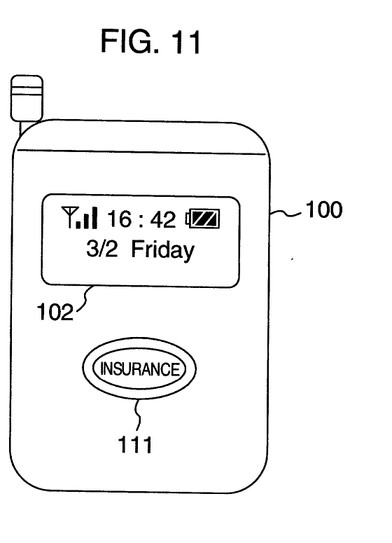

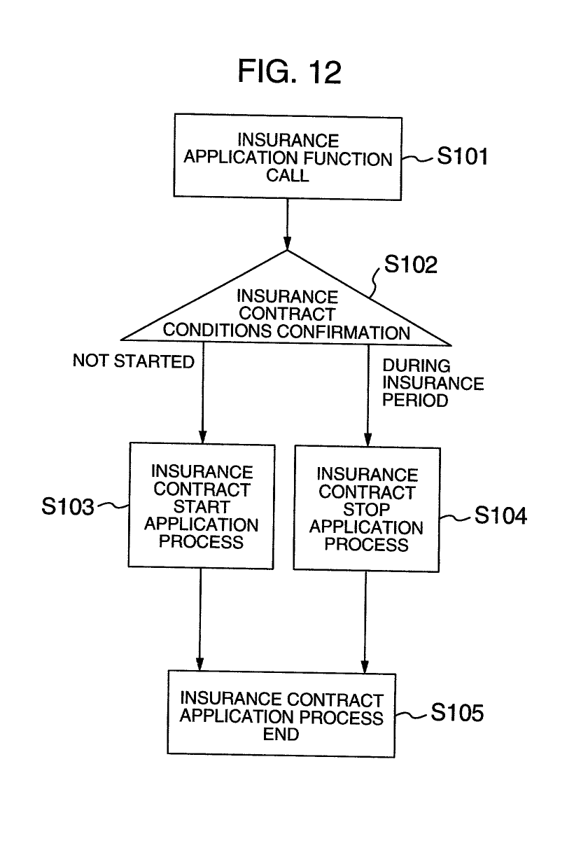

FIGS. 11 and 12 show the construction of a user interface of portable telephone 100 usable in any of the foregoing embodiments and the general flow of an insurance contract controlling process, respectively.

As shown in FIG. 11, the portable telephone 100 has an insurance key 111 for control of an insurance contract. The insurance key 111 may particularly be provided separately from a general key group (not shown) possessed by the portable telephone 100 such as ten-key similar to that of an ordinary portable telephone, may substitutionally use one key of the general key group or may use a software key displayed on the display unit 102 in place of the hardware key.

When the insurance key 111 is depressed (or is depressed in special fashion such as long-term depression) in a reception waiting state of the portable telephone 100, an insurance application function is called (S101) as shown in FIG. 12. A program of the insurance application function may be installed in advance in the portable telephone 100 or may be fetched from the insurance contract computer 300 as necessary. In the insurance application function, the present conditions of an insurance contract of the user (non-start of insurance period or during insurance period) are confirmed (S102) by reading contract conditions information held in the memory unit 122 of portable telephone 100 or by acquiring contract conditions information from the insurance contract computer 300 and are then displayed on display screen 102 shown in FIG. 11.

When the insurance contract conditions at present indicate non-start of insurance period, the insurance contract application function automatically enters an insurance contract start application process (S103) to display an insurance start application picture as exemplified in FIG. 5C on the display screen 102. Then, with the insurance key 111 depressed (or is depressed in special fashion such as depression longer than a predetermined time (hereinafter long-term depression)), the insurance application function fulfils itself to transmit insurance start application information to the insurance contract computer 300.

Conversely, when the insurance contract conditions at present indicate the insurance period in progress, the insurance contract application function automatically enters an insurance contract stop application process (S104) to display an insurance stop application picture as exemplified in FIG. 6C on the display screen 102. Then, with the insurance key 111 depressed (or is depressed in special fashion such as long-term depression), the insurance application function fulfils itself to transmit insurance stop application information to the insurance contract computer 300.

When the insurance contract start or stop application is acknowledged by the insurance contract computer 300, a message to this effect is returned from the insurance contract computer 300 and in response thereto, the insurance application function enters an insurance contract application end process (S105) to display a picture as exemplified in FIG. 5D or 6D on the display screen 102.

In this manner, through a simplified operation of mere depression of the insurance key 111 comparable to a one-touch operation, the start and stop of an insurance contract can be done.

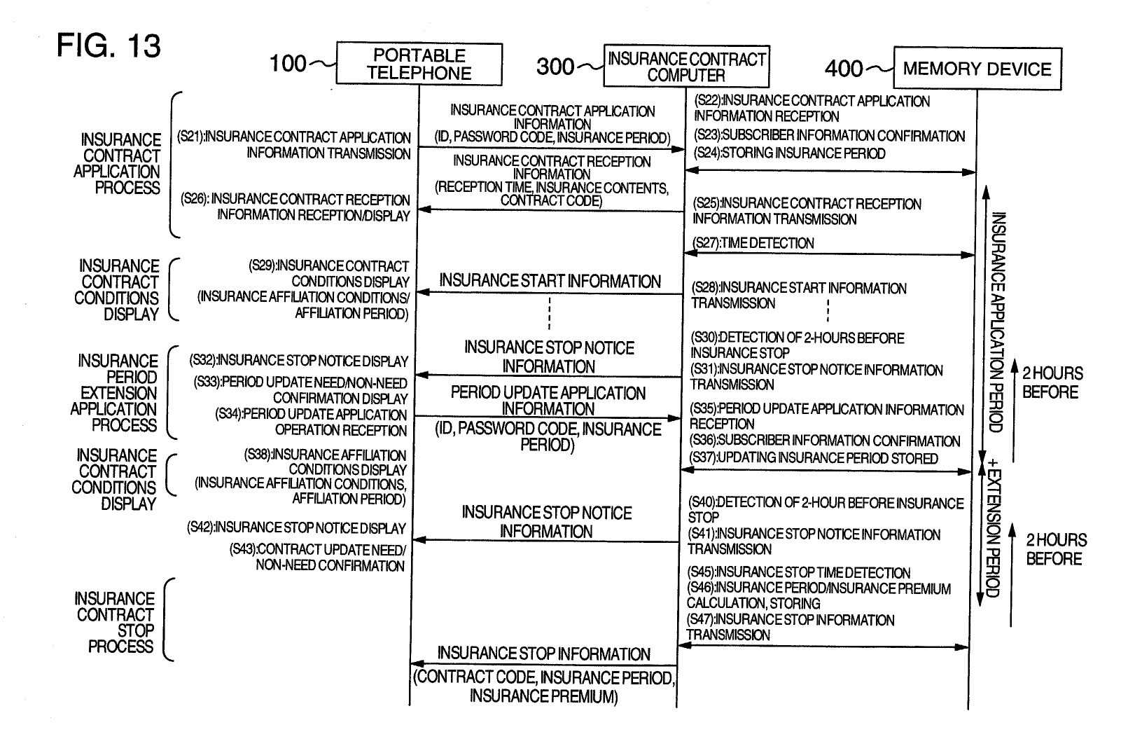

FIG. 13 shows a modified example of the process between start and stop of an insurance contract applicable to any of the foregoing embodiments.

In this process, the portable telephone 100 makes an application for an insurance contract per se (namely, entry to insurance) (or an application for reservation of an insurance period) to the insurance contract computer 300 and in this phase, schedules the time of start and stop of the insurance period. Then, as the start schedule time comes, the insurance contract computer 300 automatically starts the insurance period of the insurance contract and as the stop schedule time comes, automatically stops the insurance period. As the stop schedule time of the insurance period approaches, the insurance contract computer 300 notifies the user of it and if necessary, the user can make an application for extension of the insurance period (that is, deferment of the stop schedule time) from the portable telephone 100.

Firstly, as shown in FIG. 13, insurance contract application information is sent from the portable telephone 100 to the insurance contract computer 300 (S21). The insurance contract application information contains, in addition to the insurance subscriber ID and password number, insurance period information indicative of scheduled start date and hour of start and stop of the insurance period. The user can designate the scheduled date and hour of the insurance period.

When receiving the insurance contract application information (S22), the insurance contract computer 300 carries out subscriber information confirmation to confirm that the application comes from an authorized insurance subscriber (S23) and then, acknowledges the receipt of the insurance contract application and allots a contract code to that information. Thereafter, the computer 300 stores the contract code, reception date and hour and the insurance period information on the insurance contract information 332 in the memory device 400 shown in FIG. 3 (S24). Subsequently, the insurance contract computer 300 returns insurance contract reception information to the portable telephone 100 (S25). The insurance contract reception information contains the reception date and hour, the contents of insurance (inclusive of the aforementioned insurance period information) and the contract code. The portable telephone 100 receives the insurance contract reception information and displays the contents of it (S26).

The insurance contract computer 300 continuously detects time (S27) and when the start schedule date and hour designated by the insurance period information comes, it starts the insurance period of the insurance contract and transmits the insurance start information to the portable telephone 100 by electronic mail for portable telephone (S28). The portable telephone 100 receives the insurance start information and displays an insurance conditions picture indicative of the insurance period proceeding at present and the start date and hour and stop scheduled date and hour of the insurance period (S29).

Subsequently, when the insurance contract computer 300 detects that the stop schedule date and hour designated by the insurance period information somewhat approaches (for example, 2 hours before the stop scheduled date and hour) (S30), it transmits insurance stop notice information to the portable telephone 100 by electronic mail for portable telephone (S31). The insurance stop notice information contains a stop schedule time. The portable telephone 100 receives the insurance stop notice information to display the contents of it (S32). Then, it inquires the user about need/non-need of update (extension) of the insurance period (S33). When the user operates update (extension) of the insurance period, the portable telephone 100 responds thereto to send period update (extension) application information to the insurance contract computer 300 (S34). The period update (extension) application information contains, in addition to the insurance subscriber ID and contract code, insurance period information indicative of the deferred stop schedule date and hour.

Receiving the period update (extension) application information (S35), the insurance contract computer 300 carries out subscriber information confirmation to confirm that the application comes from the authorized insurance subscriber (S36) and on the basis of the period update (extension) application information, updates the insurance period stop schedule date and hour stored in the memory device 400 to the deferred date and hour (S37).

Thereafter, the portable telephone 100 displays an insurance condition picture indicating the insurance period proceeding at present, the insurance period start date and hour and the updated stop schedule date and hour (S38).

When the insurance contract computer 300 subsequently detects that the updated stop schedule date and hour somewhat approaches (for example, 2 hours before the stop schedule date and hour) (S40), it again transmits the insurance stop notice information to the portable telephone 100 by electronic mail for portable telephone (S41). The insurance stop notice information contains the deferred stop schedule time. The portable telephone 100 receiving the insurance stop notice information displays the contents of it (S42) and then, inquires the user about need/non-need of further update (extension) of the insurance period (S43). Unless the user operates the update (extension) of the insurance period, the insurance period will not be updated further.

Thereafter, when the insurance contract computer 300 detects that the updated stop schedule date and hour comes (S45), it stops the insurance period, calculates a time count of the insurance period from the start date and hour and stop date and hour, calculates an insurance premium on the basis of the time count and stores the calculation results on the insurance contract information 332 in the memory device 400 (S46). Then, the insurance contract computer 300 transmits the insurance stop information to the portable telephone 100 by electronic mail for portable telephone (S47). The insurance stop information contains the contract code, insurance period and insurance premium. In this manner, the insurance contract is stopped automatically.

Since the insurance contract is stopped automatically as described above, the insurance period can be prevented from keeping continuing even if the user forgets to perform the stop operation.

Incidentally, in the process shown in FIG. 13, the schedule date and hour of start and stop of the insurance period are designated at the time that the user initially makes an application for insurance contract and thereafter, the insurance period is started automatically when the start schedule date and hour comes and the insurance period is stopped automatically when the stop schedule date and hour comes. But instead, as in the process shown in FIG. 4, the insurance period may be started automatically at the time that the user makes an application for start of an insurance contract (namely, the insurance period start is the same as that in the process shown in FIG. 4) and then, the stop schedule date and hour of the insurance period (or the length of the insurance period) may be designated when the application for start is made so that the insurance period may be stopped automatically when the stop schedule date and hour comes. In updating the insurance period by making an application therefor from the portable telephone 100, not only extension but also shortening may be permitted.

In the process of FIG. 13, the insurance stop notice is given from the insurance contract computer 300 to the portable telephone 100 but instead, the portable telephone 100 may manage the insurance period to give the insurance stop notice to the user opportunely.

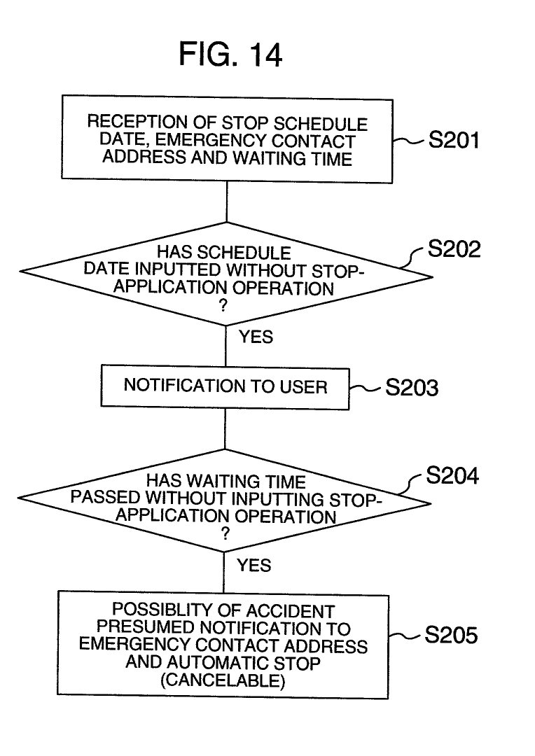

FIG. 14 shows the additional processing function capable of being incorporated in the insurance contract computer 300 and applicable to any of the foregoing embodiments.

A process shown in FIG. 4 is for the portable telephone 100 to make use of the function of controlling the insurance period so as to infer a possibility that a serious insurance accident occurs and make contact with the persons concerned without delay.

As shown in FIG. 14, when the user makes an application for start of an insurance contract, the insurance contract computer receives designation of the stop schedule date and hour of insurance period, emergency contact place (for example, electronic address, telephone number and address of family or work place) and waiting time (for example, 24 hours or 36 hours) from the user and stores them (S201). The designation of the emergency contact place can be simplified by, for example, choosing a desired person as emergency contact destination from an address note inside the portable telephone 100 when the user makes an application for start of an insurance contract by way of the portable telephone 100.

After that, as the designated stop schedule date and hour comes (or as the stop schedule date and time approaches as in the case of the process shown in FIG. 13) (S202), the insurance contract computer notifies a message to this effect to the portable telephone 100 of the user by electronic mail for portable telephone (S203), thereby urging the user to make communication for applying extension or stop of the insurance period without delay.

If, after the communication urging, the designated stop schedule date and hour is followed by a lapse of further designated waiting time while the insurance contract computer 300 receiving no communication from the portable telephone 100 of the user (S204), the insurance contract computer 300 determines that there is a possibility that an accident occurs which disables the user to make contact and notifies (S205) the designated emergency contact place by electronic mail or telephone to ask it to confirm a state of the user. Concurrently therewith, the insurance contract computer 300 may automatically stop the insurance period (this stoppage may be cancelled later by a statement made by the user). If the insurance contract computer 300 grasps position information of the user through the method described in connection with FIGS. 7 to 10, the position information may also be notified to the emergency contact place. Further, the insurance contract computer 300 may also automatically notify a predetermined organ for giving accident sufferer rescue service of the accident occurrence possibility and the user's position information by electronic mail or other electronic means.

Further, a contact place (identical to or different from the aforementioned emergency contact place) of a specified person who follows a procedure such as insurance claim in place of the user himself or herself in the event of the occurrence of insurable contingency risk may also be received from the user and stored by the insurance computer 300 at the time of insurance entry registration or insurance start application. Then, at a predetermined occasion, for example, at the time of completion of acknowledgment of an insurance start application, at a suitable occasion during the insurance period, at the time that the insurance period is stopped or at the time that the fact of occurrence of insurable contingency risk or possibility of it is recognized, contract information necessary for prosecuting the insurance claim procedure such as contract number of the insurance contract, contract code and various insurance conditions may be notified from the insurance computer 300 to the specified person by electronic mail or by mail.

By virtue of the above function, the occurrence of insurable contingency risk can be dealt with steadily to improve the reliability of the insurance goods.

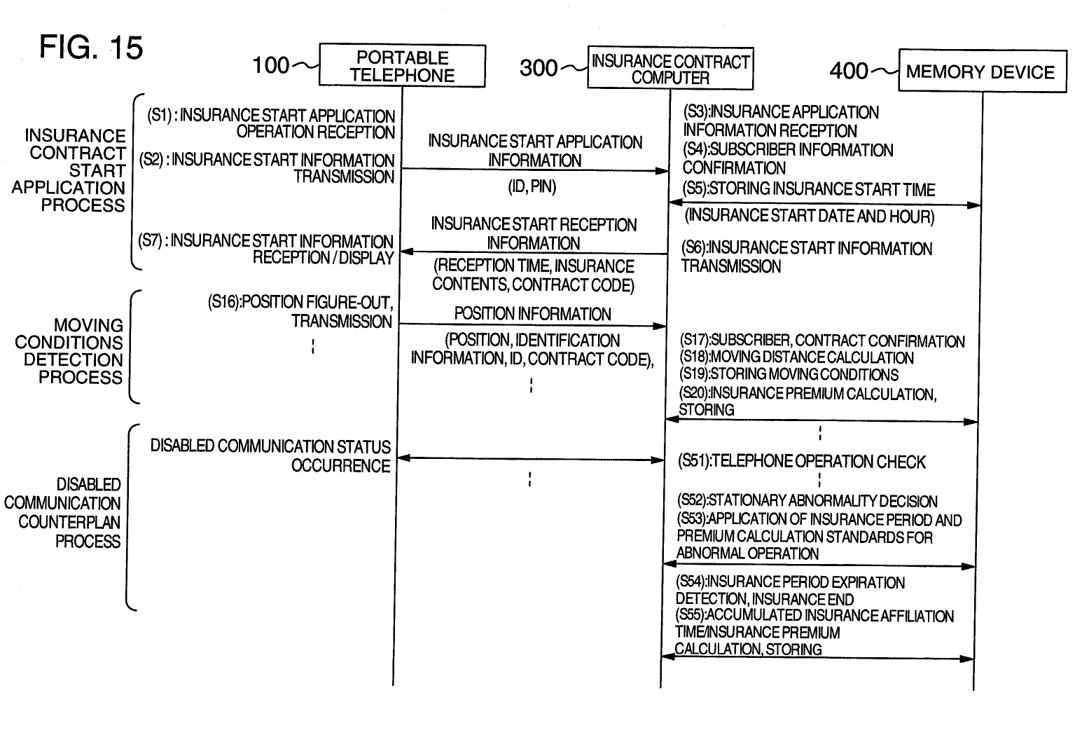

FIG. 15 shows a process flow concerning handling in the case of detection of the position and moving distance of the user (portable telephone) by utilizing GPS or the aforementioned specified apparatus and concerning measures against switch-off of the power supply in the portable telephone, loss of the portable telephone or battery-up during travel (without a charger carried).

In FIG. 15, the flow until the step S20, that is, the flow for the insurance contract computer 300 to calculate the premium by using the position information from the portable telephone 100 is the same as that already described in connection with FIG. 8. The insurance contract computer 300 checks periodically or opportunely (for example, when the position information remains to be conditioned not to come from the portable telephone 100 for a predetermined time or more) whether the portable telephone during the insurance period operates normally (S51). As a result, in the event that the portable telephone 100 is recognized as not being in normal operation for a predetermined time (for example, 24 hours or 3 days though changeable depending on the kind of insurance), the insurance contract computer 300 determines that stationary abnormality (such as battery-up, a fault or the like) takes place in the portable telephone 100 (S52). Then, the insurance contract computer 300 reads from the memory device 400 insurance conditions (insurance period and premium calculation standards) applicable to abnormal operation settled in advance at the time of entry and applies them to the insurance contract (S53). The insurance contract computer 300 now controls the insurance contract on the basis of the insurance conditions applicable to abnormal operation regardless of the present conditions of the portable telephone 100. For example, the computer carries out such control operations as ending automatically the insurance at the time that an insurance contract for abnormal operation expires (S54) or calculating the insurance premium for the remainder of insurance period following the final reception of the position information in accordance with the premium calculation standards for abnormal operation to calculate a final insurance premium (S55).

In the event that the stationary abnormality is detected, the insurance contract computer 300 may try to communicate with the user through a substitutive communication method such as electronic mail or WWW (world wide wave) based on telephone or personal computer before the insurance conditions for abnormal operation as above are applied. If communication with the user is successful or the user spontaneously makes contact, end control of the insurance contract or the premium calculation may be carried out in accordance with the results of the communication with the user. If communication with the user fails, the control operation under the insurance conditions for abnormal operation as above may be applied. If a call center or a server on Internet capable of communicating with the user through the above substitutive communication method in the event of fault/loss/death of battery in the portable telephone 100 succeeds in communicating with the user, it is preferable that authentication information from the user (user name, user telephone number, birth date or password) be received to confirm the user himself or herself and thereafter the insurance be controlled.

The embodiments of the invention have been set forth so far but the foregoing embodiments are for illustrative purpose only and the scope of the invention is in no way limited to them. Accordingly, the present invention can be carried out in various ways without departing from the gist of the invention.

For example, in the foregoing embodiments, the effectuation/end of insurance contract is clearly discriminated from the start/stop of insurance period so that the insurance period start/stop may be controlled by the designation from the portable telephone 100 in respect of an insurance contract effected in advance. But this is not always necessary and for example, in accordance with start designation from the portable telephone 100, effectuation of an insurance contract per se having the contents of contract settled in advance and start of the insurance period may occur at a time or in accordance with end designation from the portable telephone 100, end of the insurance period and end of the insurance contract per se may occur at a time.

While in the foregoing embodiments information necessary for effectuation of insurance contract such as identity information of the user is registered in advance in the memory device on the insurance contract computer side but this is not always necessary. For example, the insurance contract computer may receive and utilize identity information, for instance, registered in advance in the portable telephone of the user or identity information may be stored on the external apparatus such as an IC card carried by the user and it may be presented to the insurance contract computer as necessary.

In the foregoing embodiments, the insurance period has been described as being an example of a periodicity condition for insurance contract and the insurance premium or insured amount has been described as being an example of a moneyed condition. But, of various kinds of insurance goods at present or in future, goods may have a periodicity condition other than the insurance period and a moneyed condition other than the insurance premium or insured amount. Control according to the present invention may also be applied to the periodicity condition and moneyed condition of goods as above.

While in the foregoing embodiments the portable telephone informs the user of the present state of insurance period and the like by using the screen, the user may be notified by using voice or lamp display such as LED in combination with the screen or in place of the screen. Further, in addition to the present state of the insurance period serving as information notified to the user, various kinds of information such as accumulated time starting with the insurance period start and ending in the present, the present position and the moving distance may be notified to the user.

1. An insurance contract management system for managing an insurance contract of a user by using a computer, comprising:
a signal receiving unit for receiving an insurance control signal concerning a contract condition of said insurance contract from a portable mobile communication terminal carried by said user; and
an insurance control unit for controlling said insurance contract on the basis of said received insurance control signal.

2. An insurance contract management system according to claim 1, wherein said insurance control signal contains information concerning a periodicity condition of said insurance contract, and said insurance control unit controls the periodicity condition of said insurance contract on the basis of said information.

3. An insurance contract management system according to claim 1, wherein said insurance control signal contains information concerning entry into insurance and said insurance control unit control effectuation of said insurance contract on the basis of said information.

4. An insurance contract management system according to claim 1, wherein said insurance control signal contains information concerning cancellation of insurance and said insurance control unit controls end of said insurance contract on the basis of said information.

5. An insurance contract management system according to claim 1 further comprising a memory unit for storing in advance identity information for identifying said user,
wherein said insurance control unit can consult the identity information stored in said memory unit when controlling said insurance contract, whereby when transmitting said insurance control signal from the portable mobile communication terminal, said user need not input identity information of his or her own to said portable mobile communication terminal.

6. An insurance contract management system according to claim 2, wherein said insurance control unit controls a moneyed condition of said insurance contract on the basis of said periodicity condition.

7. An insurance contract management system according to claim 1, wherein said signal receiving unit further receives an information signal concerning a position or moving distance of said portable mobile communication terminal, and said insurance control unit controls the contract condition of said insurance contract on the basis of said information signal.

8. An insurance contract management system according to claim 1, wherein said signal receiving unit further receives an information signal concerning the distance relation between said portable mobile communication terminal and a predetermined specified apparatus, and said insurance control unit controls the contract condition of said insurance contract on the basis of said information signal.

9. An insurance contract management system according to claim 1, wherein said signal receiving unit further receives an information signal concerning a state of use of a specified traffic unit by said user, and said insurance control unit controls the contract condition of said insurance contract on the basis of said information signal.

10. An insurance contract management system according to claim 2, wherein said insurance control signal contains a signal for changing the periodicity condition already controlled by said insurance control unit, and said insurance control unit changes said periodicity condition on the basis of said signal.

11. An insurance contract management system according to claim 1 further comprising an insurance contents notifying unit for notifying predetermined information concerning said insurance contract to a contact place designated in advance by said user.

12. An insurance contract management system according to claim 1 further comprising:
an accident supposing unit for monitoring a communication state of said portable mobile communication terminal to suppose the occurrence of an accident on the basis of said communication state; and
an accident reporting unit for sending information to a predetermined contact place when the occurrence of an accident is supposed by said accident supposing unit.

13. A method for controlling an insurance contract of a user by using a computer, comprising the steps of:
receiving an insurance control signal concerning a contract condition of said insurance contract from a portable mobile communication terminal carried by said user; and
controlling said insurance contract on the basis of said received insurance control signal.

14. A portable mobile communication terminal usable by a user for controlling an insurance contract, comprising:
a radio communication unit for connecting to an insurance contract computer adapted to manage said insurance contract; and
an insurance control signal transmitting unit for transmitting to said insurance contract computer an insurance control signal for control of a contract condition of said insurance contract.

15. A portable mobile communication terminal according to claim 14 further comprising a memory unit for storing user identification information for causing said insurance contract computer to identify said user,
wherein said insurance control signal transmitting unit transmits the user identification information stored in said memory unit, together with said insurance control signal, to said insurance contract computer, whereby said user need not input identity information of his or her own to said portable mobile communication terminal.

16. A portable mobile communication terminal according to claim 14 further comprising a unit for generating an information signal concerning a position or moving distance of said portable mobile communication terminal,
wherein said insurance control signal transmitting unit transmits said information signal to said insurance contract computer.

17. A portable mobile communication terminal according to claim 14 further comprising a unit for generating an information signal concerning the distance relation between said portable mobile communication terminal and a predetermined specified apparatus,
wherein said insurance control signal transmitting unit transmits said information signal to said insurance contract computer.

18. A portable mobile communication terminal according to claim 14 further comprising a unit for generating an information signal concerning a state of use of a specified traffic unit by said user,
wherein said insurance control signal transmitting unit transmits said information signal to said insurance contract computer.

19. A portable mobile communication terminal according to claim 14 further comprising a unit for informing said user of the present state of the periodicity condition of said insurance contract.

20. A portable mobile communication system according to claim 14 further comprising an insurance control key operable to control the contract condition of said insurance contract,
wherein said insurance control signal can be transmitted by operating said key only.
